(19) United States
(12) Patent Application Publication
(10) Pub. No.: US 2023/0214742 A1
(43) Pub. Date: Jul. 6, 2023

(54) INTELLIGENT PERSONALITY MATCHING WITH VIRTUAL REALITY

(71) Applicant: International Business Machines Corporation, Armonk, NY (US)

(72) Inventors: EWA KARWETA, New York, NY (US); Jennifer M. Hatfield, San Francisco, CA (US); Danielle Espine, Jamaica, NY (US); Ourania Svoronou, New York, NY (US); Lucia Larise Stavarache, Columbus, OH (US)

(21) Appl. No.: 17/569,711

(22) Filed: Jan. 6, 2022

(51) Int. Cl. G06Q 10/06; G06Q 10/10

(52) U.S. Cl. CPC G06Q 10/063118; G06Q 10/103; G06Q 10/06312; G06Q 10/063116

(57) ABSTRACT

An approach for predicting team dynamics based on changing circumstances. The approach retrieves profiles associated with a group of first team members of a project team. The approach selects a virtual reality (VR) scenario to interact with the group of first team members. The approach executes the VR scenario based on the profiles. The approach receives VR input from an interacting team member interacting with the VR scenario. The approach predicts responses of the group of first team members to the VR input. The approach analyzes the responses and provides the interacting team member a ranked list of scenario outcomes.

### TECHNICAL FIELD

The present invention relates generally to workplace efficiency, and specifically, to personality matching with the use of virtual reality.

### BACKGROUND

Uncomfortable and inefficient workplaces are created when people are not performing or communicating at their best due to remote workplace interaction, personality and/or work method conflicts. This ineffective interaction can result in low team morale, risk for project schedules and unhappy customers/clients. When working in a remote team environment, understanding a team member becomes more difficult because of a disconnect with personalities and emotions based on a remote meeting environment. Accordingly, team and project productivity can decline because of team members become out of touch with each other with respect to these characteristics.

Agility and adaptability are some of the most cherished skills in our fast-paced world. However, it can be very hard to predict how teams, individuals or clients will react to changing scenarios. One way to train these soft skills is “on the job training,” but the inability to train this skill or effectively predict shifts in circumstances for the entire team costs a company money, team morale and client trust. A need has arisen for evaluating real-life scenarios for a company's clients, team members and teams to both anticipate future problems and train adaptability and agility.

### BRIEF SUMMARY

According to an embodiment of the present invention, a computer-implemented method for predicting team dynamics based on changing circumstances, the computer-implemented method comprising: retrieving, by one or more processors, profiles representing a group of first team members; selecting, by the one or more processors, a virtual reality (VR) scenario to interact with the group of first team members; executing, by the one or more processors, the VR scenario based on the profiles; receiving, by the one or more processors, VR input from a second team member interacting with the VR scenario; predicting, by the one or more processors, responses of the group of first team members based on the VR input; and analyzing, by the one or more processors, the responses and providing the second team member a ranked list of scenario outcomes.

According to an embodiment of the present invention, a computer program product for predicting team dynamics based on changing circumstances, the computer program product comprising: one or more non-transitory computer readable storage media and program instructions stored on the one or more non-transitory computer readable storage media, the program instructions comprising: program instructions to retrieve profiles representing a group of first team members; program instructions to select a virtual reality (VR) scenario to interact with the group of first team members; program instructions to execute the VR scenario based on the profiles; program instructions to receive VR input from a second team member interacting with the VR scenario; program instructions to predict responses of the group of first team members based on the VR input; and program instructions to analyze the responses and providing the second team member a ranked list of scenario outcomes.

According to an embodiment of the present invention, a computer system for predicting team dynamics based on changing circumstances, the computer system comprising: one or more computer processors; one or more non-transitory computer readable storage media; and program instructions stored on the one or more non-transitory computer readable storage media, the program instructions comprising: program instructions to retrieve profiles representing a group of first team members; program instructions to select a virtual reality (VR) scenario to interact with the group of first team members; program instructions to execute the VR scenario based on the profiles; program instructions to receive VR input from a second team member interacting with the VR scenario wherein the input comprises virtual verbal interaction and virtual physical interaction; program instructions to predict responses of the group of first team members based on the VR input; and program instructions to analyze the responses and providing the second team member a ranked list of scenario outcomes.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of optimizing workplace team efficiency based on intelligent personality matching with virtual reality. Embodiments of the present invention can provide the capability to allow team leaders and/or managers to run through potential future scenarios and provide suggestions about the team members involved in the simulation based on their persona. Multiple different scenario types can be defined such as, but not limited to, changing the work environment, playing out the impact of key decisions, and/or changing communication styles on the different persona types.

It should be noted that in a fast-paced world we are living in, a wrong decision can cost a team, a project or an organization a significant amount of money or good will. Addressing the problem of predicting how team members or clients will react to change, the embodiments described herein provide a virtual reality (VR) environment to use personality predictive modeling (PPM) to immerse team leaders and/or managers in future scenarios to prepare and adapt quicker to change or unexpected situations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

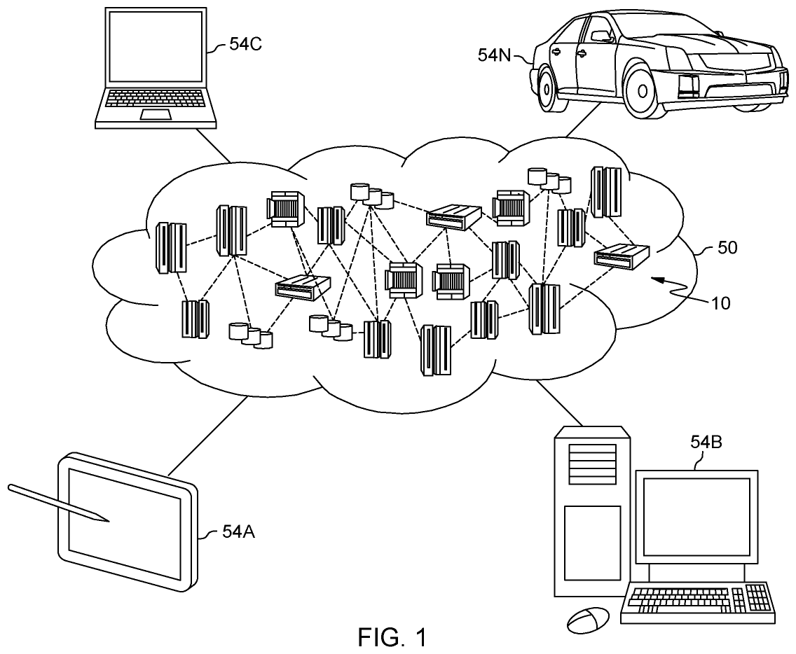

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

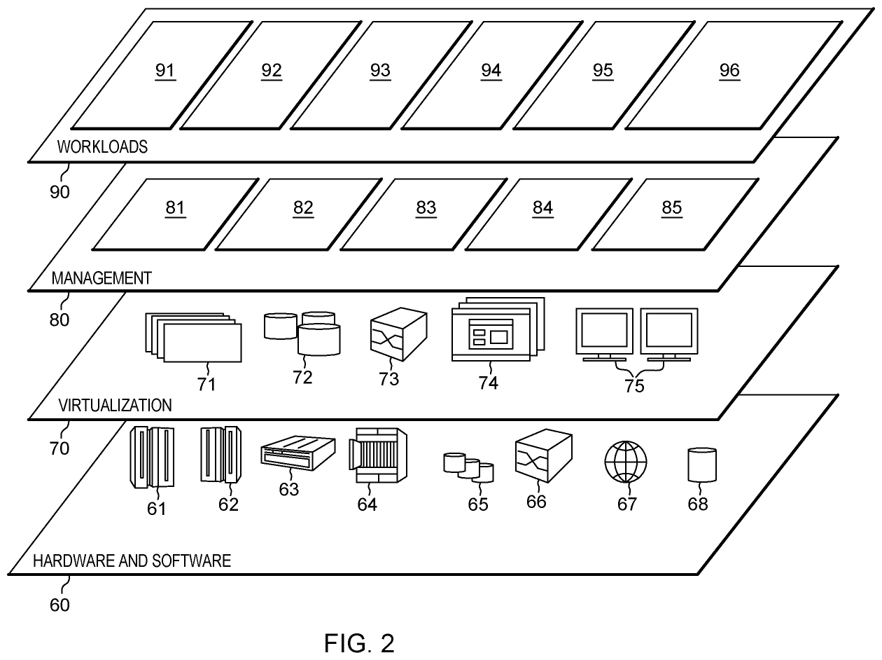

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and team virtual reality management 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

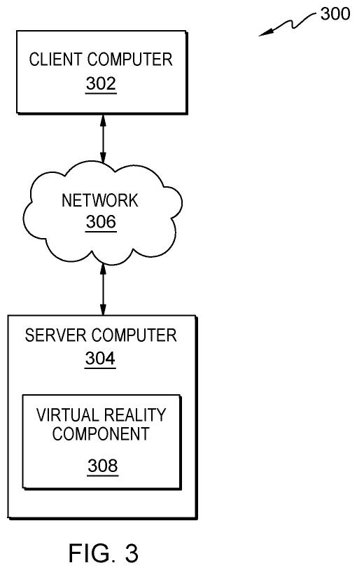

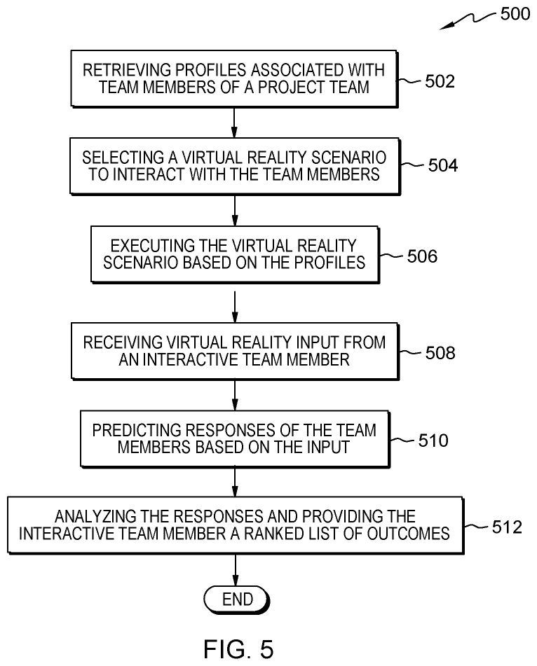

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram, showing a storage optimization system, to which the invention principles may be applied. The architecture 300 comprises a client computer 302, a virtual reality component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within intelligent personality matching virtual reality environment of architecture 300 via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within intelligent personality matching virtual reality environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

In one embodiment of the present invention, virtual reality component 308, operational on server computer 304, can generate and run virtual reality (VR) models of potential future scenarios affecting the team members to predict how the team dynamic could shift when faced with new circumstances. In another aspect of an embodiment, virtual reality component 308 can suggest resolutions and support for the team and the team members. It should be noted that the VR models can be used for Client Digital Transformation Efforts (CDTE) to determine which team members would be best suited for re-training based on the scenario circumstances.

In another embodiment of the present invention, virtual reality component 308 can provide the capability for team members to enter a VR environment and “opt-in” to a simulation. It should be noted that “opt-in,” as performed through virtual reality component 308, does not require a team member to have a predefined profile. It should further be noted that “opt-in” can include, but is not limited to, monitoring of the team member in the VR environment to collect behavior data for machine learning of personality types for future use by the embodiments.

In another aspect of an embodiment of the present invention, if a team member logs in using their profile, virtual reality component 308 can use the collected data to enhance the team member's profile. It should be noted that if a team member chooses to log-in without the use of a profile, then the collected data can be cataloged to enhance one or more standard personality types derived from the tests and VR sessions. It should be noted that team member “log-in” can be accomplished via a VR graphical user interface (GUI) associated with virtual reality component 308.

In another embodiment of the present invention, virtual reality component 308 can provide the capability for team members to search a database to select specific profiles or generic personality types created from the collected data. It should be noted that profiles and personality types can be selected via the VR GUI. In another aspect of an embodiment, if a team member wishes to provide their own profile, virtual reality component 308 can provide a list of suggested profiles for selection. It should be noted that the list is based on profiles that previously matched the team member or profiles used by virtual reality component 308 to analyze the team member. In another aspect of an embodiment of the present invention, virtual reality component 308 can use profiles that belong to the same sector within the company. It should be noted that the same sector of the company can be defined as terms such as, but not limited to, the same job title, the same career level, the same amount of experience in the current position, the number of completed projects, etc.

In another aspect of an embodiment, virtual reality component 308 can provide a team member the capability to select a VR scenario to experience. It should be noted that the scenarios can be preconfigured and/or the scenarios can be added with new code written and uploaded to virtual reality component 308. It should further be noted that scenarios can include circumstances such as, but not limited to, how the interaction evolves, the duration of the interaction, similar interactions, adjusted parameters of an interaction, etc. In another aspect of an embodiment, the scenarios can be selected via the VR GUI and can include, but not limited to, multiple scenarios or scenarios customized by a team member, team leader and/or manager. It should be noted that a VR scenario can be work-related or non-work-related.

In another aspect of an embodiment, virtual reality component 308 can present a team member with a selected VR scenario with the selected parameter, e.g., personas, personalities, etc. In another aspect of an embodiment, a team member has the option to interact with the scenario or observe the scenario. It should be noted that a team member has the capability to pause the scenario for reflection and/or review. In another aspect of an embodiment, virtual reality component 308 can display percent likelihood scores of a team member personality acting in a particular way to the observing team member. In another aspect of an embodiment, virtual reality component 308 can provide the capability for a team member to interact with the VR scenario and personalities, and to collect team member input and re-calculate the likely behavior patterns of all personalities. In another aspect of an embodiment, virtual reality component 308 can provide the team member warnings of potential conflicts, risks, opportunities, or action options via the VR GUI to adjust team member behavior.

In another aspect of an embodiment, virtual reality component 308 can provide a summary of the scenario and the capability to replay the session with the same personalities or start a new session. It should be noted that actions and interactions can be analyzed, and a full disclosure is available for the team member to retain at the completion of the scenario. In another aspect of an embodiment, virtual reality component 308 can review a full list of scores for the actions taken and for other possible actions, providing instant feedback to the team member on what may have worked better for the selected scenario with the selected personalities.

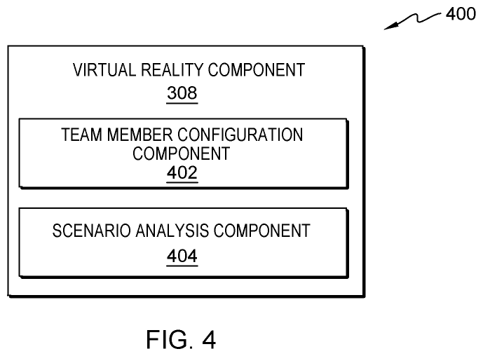

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, a different number of elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a virtual reality component 308, which can further comprise a team member configuration component 402 and a scenario analysis component 404.

In one aspect of an embodiment of the present invention, team member configuration component 402 can provide the capability for team members to allow access to the required personal information. In another aspect of an embodiment of the present invention, team member configuration component 402 can provide a team member the capability to enter a VR environment and “opt-in” to a virtual scenario. In another aspect of an embodiment of the present invention, team member configuration component 402 can provide a team member the capability to select individuals that have profiles or to select generic personality profiles.

Further, a team member can select potential scenarios experience in the VR environment, providing the team member the opportunity to interact with the selected personalities in the selected scenario and observe the virtual response. It should be noted that virtual reality component can provide the experience of the most likely personality reactions based on the profile and personality data sets selected by the team member, the team leader, and/or the manager.

In another aspect of an embodiment of the present invention, scenario analysis component 404 can provide a team member the capability to review a probability score of the likelihood of a particular reaction to a scenario. In another aspect of an embodiment of the present invention, scenario analysis component 404 can assess the interaction in the VR environment and predict areas of potential conflict, project risk and opportunity for project efficiency improvement. It should be noted that the team member can replay the scenario with the selected personalities or change the personalities and/or the scenario for a broader perspective on the interaction and team dynamics. Further, a team member can see the probability scores and analytics of the likely responses, scenario risks, etc. It should be noted that a team member can store the configuration and predictions from the VR scenario, e.g., send the output to their email address.

FIG. 5 is an exemplary flowchart of a method 500 for predicting team dynamics based on changing circumstances. At step 502, an embodiment can retrieve, via team member configuration component 402, profiles associated with team members of a project team. At step 504, the embodiment can select, via team member configuration component 402, a virtual reality scenario to interact with the team members. At step 506, the embodiment can execute, via scenario analysis component 404, the virtual reality scenario based on the profiles. At step 508, the embodiment can receive, via scenario analysis component 404, input from an interactive team member. At step 510, the embodiment can predict, via scenario analysis component 404, responses of the associated team members based on the input. At step 512, the embodiment can analyze, via scenario analysis component 404, the responses of the associated team members and provide the interactive team member a ranked list of outcomes.

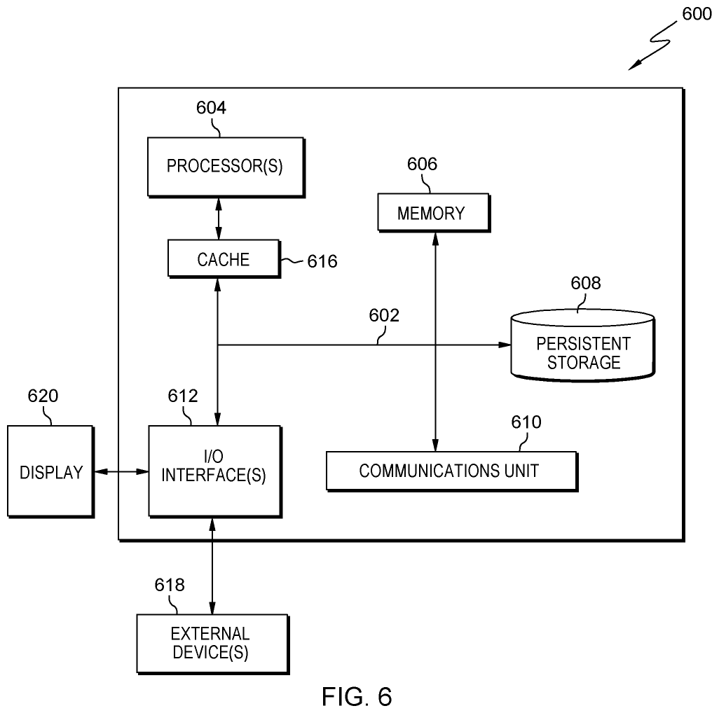

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for predicting team dynamics based on changing circumstances, the computer-implemented method comprising:
retrieving, by one or more processors, profiles representing a group of first team members;
selecting, by the one or more processors, a virtual reality (VR) scenario to interact with the group of first team members;
executing, by the one or more processors, the VR scenario based on the profiles;
receiving, by the one or more processors, VR input from a second team member interacting with the VR scenario;
predicting, by the one or more processors, responses of the group of first team members based on the VR input; and
analyzing, by the one or more processors, the responses and providing the second team member a ranked list of scenario outcomes.

2. The computer-implemented method of claim 1, further comprising:
adjusting, by the one or more processors, the group of first team members based on one or more of adding team members, removing team members, and selecting a different VR scenario; and
replaying, by the one or more processors, the VR scenario based on the adjusting.

3. The computer-implemented method of claim 2, wherein the replaying further comprises presenting the second team member with warnings of at least one of potential conflict, potential risk, or potential opportunities, and action options to adjust behavior and mitigate the warning.

4. The computer-implemented method of claim 1, wherein the profiles comprise personal profiles associated with the group of first team members, respectively, or generic personality profiles.

5. The computer-implemented method of claim 3, wherein the VR scenario comprises work-related scenarios, non-work-related scenarios, and customer interaction scenarios.

6. The computer-implemented method of claim 1, wherein the input comprises virtual verbal interaction and virtual physical interaction.

7. The computer-implemented method of claim 1, wherein the predicted responses are associated with interpersonal conflict, project risk and project improvement opportunity.

8. A computer program product for predicting team dynamics based on changing circumstances, the computer program product comprising:
one or more non-transitory computer readable storage media and program instructions stored on the one or more non-transitory computer readable storage media, the program instructions comprising:
program instructions to retrieve profiles representing a group of first team members;
program instructions to select a virtual reality (VR) scenario to interact with the group of first team members;
program instructions to execute the VR scenario based on the profiles;
program instructions to receive VR input from a second team member interacting with the VR scenario;
program instructions to predict responses of the group of first team members based on the VR input; and
program instructions to analyze the responses and providing the second team member a ranked list of scenario outcomes.

9. The computer program product of claim 8, further comprising:
program instructions to adjust the group of first team members based on one or more of adding team members, removing team members, and selecting a different VR scenario; and
program instructions to replay the VR scenario based on the adjusting.

10. The computer program product of claim 9, wherein the program instructions to replay further comprises presenting the second team member with warnings of at least one of potential conflict, potential risk, or potential opportunities, and action options to adjust behavior and mitigate the warning.

11. The computer program product of claim 8, wherein the profiles comprise personal profiles associated with the group of first team members, respectively, or generic personality profiles.

12. The computer program product of claim 9, wherein the VR scenario comprises work-related scenarios, non-work-related scenarios, and customer interaction scenarios.

13. The computer program product of claim 8, wherein the input comprises virtual verbal interaction and virtual physical interaction.

14. The computer program product of claim 8, wherein the predicted responses are associated with interpersonal conflict, project risk and project improvement opportunity.

15. A computer system for predicting team dynamics based on changing circumstances, the computer system comprising:
one or more computer processors;
one or more non-transitory computer readable storage media; and
program instructions stored on the one or more non-transitory computer readable storage media, the program instructions comprising:
program instructions to retrieve profiles representing a group of first team members;
program instructions to select a virtual reality (VR) scenario to interact with the group of first team members;
program instructions to execute the VR scenario based on the profiles;
program instructions to receive VR input from a second team member interacting with the VR scenario wherein the input comprises virtual verbal interaction and virtual physical interaction;
program instructions to predict responses of the group of first team members based on the VR input; and
program instructions to analyze the responses and providing the second team member a ranked list of scenario outcomes.

16. The computer system of claim 15, further comprising:
program instructions to adjust the group of first team members based on one or more of adding team members, removing team members, and selecting a different VR scenario; and
program instructions to replay the VR scenario based on the adjusting.

17. The computer system of claim 16, wherein the program instructions to replay further comprises presenting the second team member with warnings of at least one of potential conflict, potential risk, or potential opportunities, and action options to adjust behavior and mitigate the warning.

18. The computer system of claim 15, wherein the profiles comprise personal profiles associated with the group of first team members, respectively, or generic personality profiles.

19. The computer system of claim 16, wherein the VR scenario comprises work-related scenarios, non-work-related scenarios, and customer interaction scenarios.

20. The computer system of claim 15, wherein the predicted responses are associated with interpersonal conflict, project risk and project improvement opportunity.
